(19) United States
(12) Patent Application Publication
(10) Pub. No.: US 2015/0248735 A1
(43) Pub. Date: Sep. 3, 2015

(54) COMMUNCATION SYSTEM AND RELATED METHOD FOR ENABLING ONLINE EXCHANGE SESSIONS

(71) Applicant: Samuel STAPP, Provo, UT (US)

(72) Inventor: Samuel STAPP, Provo, UT (US)

(21) Appl. No.: 14/195,638

(22) Filed: Mar. 3, 2014

(51) Int. Cl. G06Q 50/00; G06Q 30/06; G06Q 10/02; G06Q 50/18; G06Q 50/12

(52) U.S. Cl. CPC G06Q 50/01; G06Q 50/188; G06Q 50/12; G06Q 10/02; G06Q 30/0643

(57) ABSTRACT

Communication systems and methods of administering a communication system are disclosed. A communication system includes one or more servers comprising one or more databases configured to store account information for user accounts corresponding to users. The account information includes asset information associated with each of the user accounts. The one or more servers are configured to communicate with user devices and enable the users to participate in online exchange sessions through the user devices. The online exchange sessions enable each of the users to negotiate with others of the users and agree to exchanges of the assets associated with their corresponding user accounts. A method comprises storing the account information in the one or more databases, and enabling the users to participate in the online exchange sessions.

### FIELD

The present disclosure relates generally to communication systems and related methods for administering a communication system. More specifically, the present disclosure relates to online exchange sessions for the exchange of assets comprising goods, services and combinations thereof.

### BACKGROUND

The refinement of Internet-related technology and the proliferation of mobile communication devices have caused many changes to the dissemination of information and products. For example, social networking and online commerce are increasingly becoming preferred forms of disseminating information and products. Both social and business interactions can be conducted with almost anybody in the world at almost any time. The Internet and mobile technology offer unprecedented convenience, and have extended the social and business reach of numerous people.

Much effort has been focused on using the Internet and mobile technology to extend peoples' social and business reach as far as possible, and to create business profit. For example, online marketplaces and shipping services enable people to sell goods to each other virtually anywhere in the world. Also, even well-established retail businesses have been forced to offer their goods online in order to compete with low-overhead online retailers. Some consequences of the change of business and social interactions to online mediums may include a decrease in personal touch, and a shift of focus away from local communities to a worldwide community.

### BRIEF SUMMARY

In some embodiments, the present disclosure comprises a communication system including one or more servers. The one or more servers comprise one or more databases configured to store account information including asset information associated with each of the plurality of user accounts. The one or more servers are configured to communicate with a plurality of user devices, and enable the plurality of users to participate in online exchange sessions through the plurality of user devices. The online exchange sessions enable each of the plurality of users to negotiate with others of the plurality of users and agree to exchanges of the assets associated with their corresponding user accounts.

In some embodiments, the present disclosure comprises a method of administering a communication system. The method comprises storing account information for a plurality of user accounts corresponding to a plurality of users in one or more databases. The account information includes asset information associated with each of the plurality of user accounts. The method also comprises enabling the plurality of users to participate in online exchange sessions through a plurality of user devices. The online exchange sessions enable each of the plurality of users to negotiate with others of the plurality of users and agree to exchanges of the assets associated with their corresponding user accounts.

### BRIEF DESCRIPTION OF THE DRAWINGS

FIG. 1 is simplified block diagram of a communication system;

FIG. 2 is a simplified block diagram of a representative organization for the database of FIG. 1;

FIG. 3 is a simplified block diagram of one or more servers of the communication system of FIG. 1;

FIG. 4 is an example of a simplified user profile interface of a graphical user interface for presentation to users of the communication system of FIG. 1;

FIG. 5 is an example of a simplified assets interface of a graphical user interface for presentation to users of the communication system of FIG. 1;

FIG. 6 is an example of a simplified exchange session interface of a graphical user interface for presentation to users of the communication system of FIG. 1;

FIG. 7 is a simplified plan view of a social center of the communication system of FIG. 1; and

FIG. 8 is a flowchart illustrating a method of administering the communication system of FIG. 1.

### DETAILED DESCRIPTION

In the following detailed description, reference is made to the accompanying drawings which form a part hereof, and in which is shown by way of illustration specific embodiments in which the present disclosure may be practiced. These embodiments are described in sufficient detail to enable those of ordinary skill in the art to practice the present disclosure. It should be understood, however, that the detailed description and the specific examples, while indicating examples of embodiments of the present disclosure, are given by way of illustration only and not by way of limitation. From this disclosure, various substitutions, modifications, additions rearrangements, or combinations thereof within the scope of the present disclosure may be made and will become apparent to those of ordinary skill in the art.

In accordance with common practice, the various features illustrated in the drawings may not be drawn to scale. The illustrations presented herein are not meant to be actual views of any particular apparatus (e.g., device, system, etc.) or method, but are merely idealized representations that are employed to describe various embodiments of the present disclosure. Accordingly, the dimensions of the various features may be arbitrarily expanded or reduced for clarity. In addition, some of the drawings may be simplified for clarity. Thus, the drawings may not depict all of the components of a given apparatus or all operations of a particular method.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It should be understood by a person of ordinary skill in the art that the signal may represent a bus of signals, wherein the bus may have a variety of bit widths and the present disclosure may be implemented on any number of data signals including a single data signal.

The various illustrative logical blocks, modules, circuits, and algorithm acts described in connection with embodiments disclosed herein may be implemented as electronic hardware, computer software, or combinations of both. To clearly illustrate this interchangeability of hardware and software, various illustrative components, blocks, modules, circuits, and acts are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments of the disclosure described herein.

In addition, it is noted that the embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be rearranged. A process may correspond to a method, a function, a procedure, a subroutine, a subprogram, etc. Furthermore, the methods disclosed herein may be implemented in hardware, software, or both. If implemented in software, the functions may be stored or transmitted as one or more computer-readable instructions (e.g., software code) on a computer-readable medium. Computer-readable media may include both computer storage media and communication media including any medium that facilitates transfer of a computer program from one place to another. Computer-readable media may include volatile and non-volatile memory, such as, for example, magnetic and optical storage devices, such as, for example, hard drives, disk drives, magnetic tapes, CDs (compact discs), DVDs (digital versatile discs or digital video discs), solid state storage devices (solid state hard drives), and other similar storage devices.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

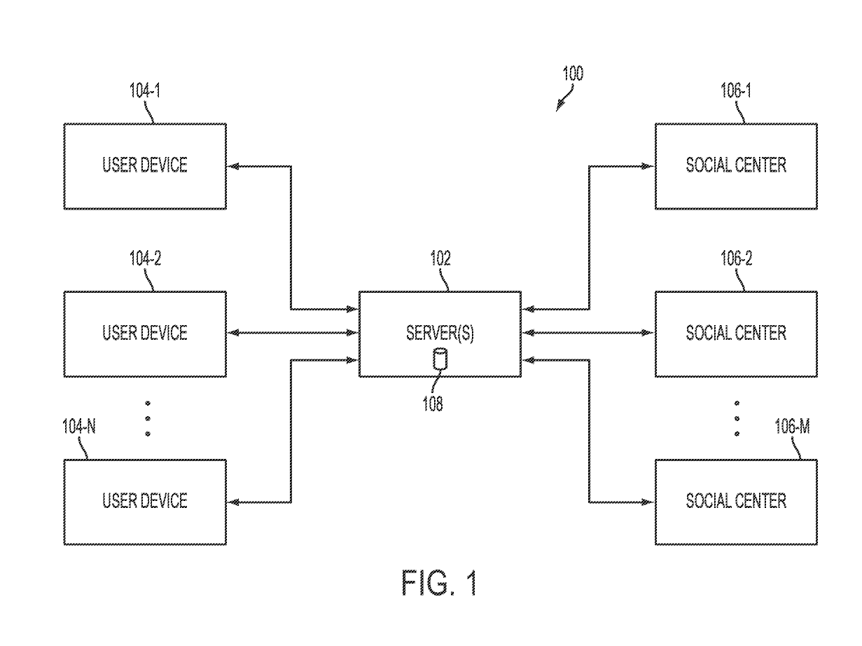

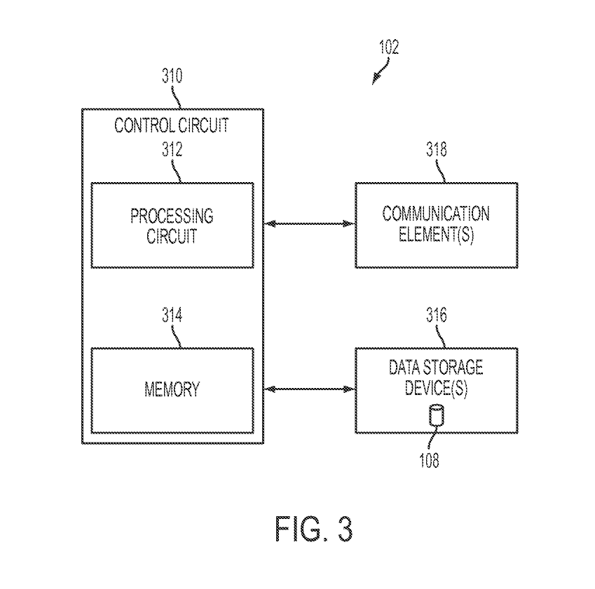

Elements described herein may include multiple instances of the same element. These elements may be generically indicated by a numerical designator (e.g., 110) and specifically indicated by the numerical indicator followed by an alphabetic designator (e.g., 110A) or a numeric indicator preceded by a “dash” (e.g., 110-1). For ease of following the description, for the most part, element number indicators begin with the number of the drawing on which the elements are introduced or most fully discussed. Thus, for example, element identifiers on a FIG. 1 will be mostly in the numerical format 1xx and elements on a FIG. 3 will be mostly in the numerical format 3xx.

Embodiments of the present disclosure include communication systems and methods for administering a communication system. The communication system may enable online and local in-person distribution of ideas and assets between users of the communication system. It should be noted that while the utility and application of the various embodiments of the present disclosure are described herein with reference to social networks, the embodiments of the present disclosure also include any environment where the online exchange of assets for other assets would be useful or helpful. As used herein, the terms “asset,” and “assets” refer to goods, services, or combinations thereof. Money, currency, credit, and other monetary exchange tokens are not an “asset,” or “assets” as used herein.

FIG. 1 is a simplified block diagram of a communication system 100. The communication system 100 may include one or more servers 102 (sometimes referred to herein simply as “server” 102) configured to communicate with a plurality of user devices 104-1, 104-2, . . . 104-N (sometimes referred to herein simply individually as “user device” 104 and together as “user devices” 104) and a plurality of social centers 106-1, 106-2, . . . 106-M (sometimes referred to herein simply individually as “social center” 106 and together as “social centers” 106).

The server 102 may be configured to provide network services to users of the user devices 104 (e.g., with an online social network) and the social centers 106. In general, the server 102 may facilitate an online community for different users to interact (e.g., view and share information, arrange events, exchange assets) in a localized way. Each user may have his or her own user account managed by the server 102, the user account being used to associate account information (e.g., profile information, asset information, discussion information, event information, etc.) with the user. User accounts may include user accounts for individual persons, groups of people, places (e.g., social centers 106, places of business, places with other significance, etc.), causes (e.g., charitable causes, non-profit causes, general causes), etc. As used herein a user account associated with an individual is referred to as an “individual user account,” a user account associated with a group of people is referred to as a “group user account,” a user account associated with a place is referred to as a “place user account,” and a user account associated with a cause is referred to as a “cause user account.” Other types of user accounts are contemplated if different categories of users are desired. Each user account type may have different privileges associated therewith according to the features available for that user account type.

The server 102 may store one or more databases 108 (sometimes referred to herein simply as “database” 108) configured to store account information corresponding to the different user accounts of the communication system. For example, the server 102 may enable the users to provide information through their user devices 104 about their user accounts, such as their profile information, their assets available for exchange, redemption designations for the assets (e.g., for trade, for sale, for rent, for free-of-charge sharing), and other relevant information as will be discussed more fully below. The server 102 may further be configured to enable the users to browse account information associated with the user accounts of other users. For example, the server 102 may transmit the account information of the communication system 100 to the user devices 104 to present user profiles (e.g., person profiles, group profiles, place profiles, cause profiles, etc.) to the users according to queries, browsing, etc., of the users on their user devices 104.

The user devices 104 may include personal communication devices owned by the users, such as, for example, desktop computers, notebook computers, and mobile communication devices (e.g., tablet computers, smartphones, cellular phones, personal digital assistants (PDAs), etc.) The user devices 104 may also include communication devices provided in the social centers 106 for use by the users. The user devices 104 may be configured with software (e.g., web browsers, software applications, etc.) that enables the user devices 104 to interact with the server 102 through one or more networks (e.g., Internet protocol (IP) networks, mobile wireless networks, etc.). The user devices 104 may be the interface between the users and the server 102.

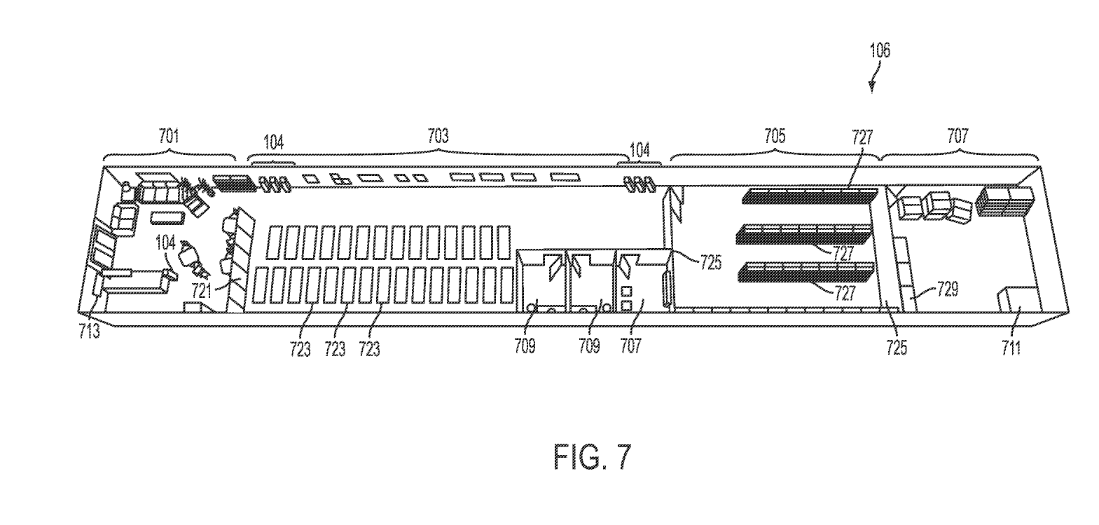

The social centers 106 may include brick-and-mortar venues that supplement the online interactions between the users. For example, the social centers 106 may provide a venue for local asset exchange (e.g., for assets exchanged during the online exchange sessions or sold online), events and meetings organized online, and dissemination of local art and ideas. In some embodiments, the social centers 106 may be places with place user accounts associated therewith, and that are registered with the communication system 100 as social centers 106. The social centers 106 may include one or more of a dining area, an event area, a retail area, and storage areas, as will be discussed in more detail below with respect to FIG. 7. Not all places with place user accounts may be social centers 106. In some embodiments, any place with a place user account may participate in the communication system 100 similarly to a social center 106 to the extent the facilities at the place are adequate for said participation.

The server 102 may also be configured to enable the users to create and maintain user accounts. For example, if a user joins the communication system 100, the user may be requested to input certain information from the user to the user device 104, which information may be transmitted to the server 102 for storage in the database 108. For example, the information from the user may include the user's name, email address, password, birthday, gender, interests, or other information about the user. The user may also be requested to indicate geographic regions (sometimes referred to herein as “blocks”) where the user desires to interact with other users (e.g., neighborhoods, cities, segments of cities, or particular addresses within cities). Accordingly, each user account may be associated with geographic information.

The server 102 may be configured to enable the users to network with other users via the user devices 104. By way of non-limiting example, the server 102 may be configured to provide the users with information about other users (e.g., persons, groups, places, causes), that share similar geographic information, interests, or a combination thereof. By way of non-limiting example, the server 102 may be configured to enable the users to search for other users by geographic information, interests, or other account information, and view user profiles, or portions thereof, revealed by the searches. The server 102 may also be configured to enable various online interactions between users (e.g., discussions, event planning, marketplaces, etc.). The server 102 may further be configured to enable such interactions between users that share similar geographic information. As an example of an online interaction, the server 102 may be configured to enable the users to participate in online exchange sessions through the user devices 104. The online exchange sessions may enable the users to negotiate with other users and agree to exchange assets associated with their corresponding user accounts with each other. In other words, the server 102 may be configured to enable the users to agree to trade their assets online for other users' assets.

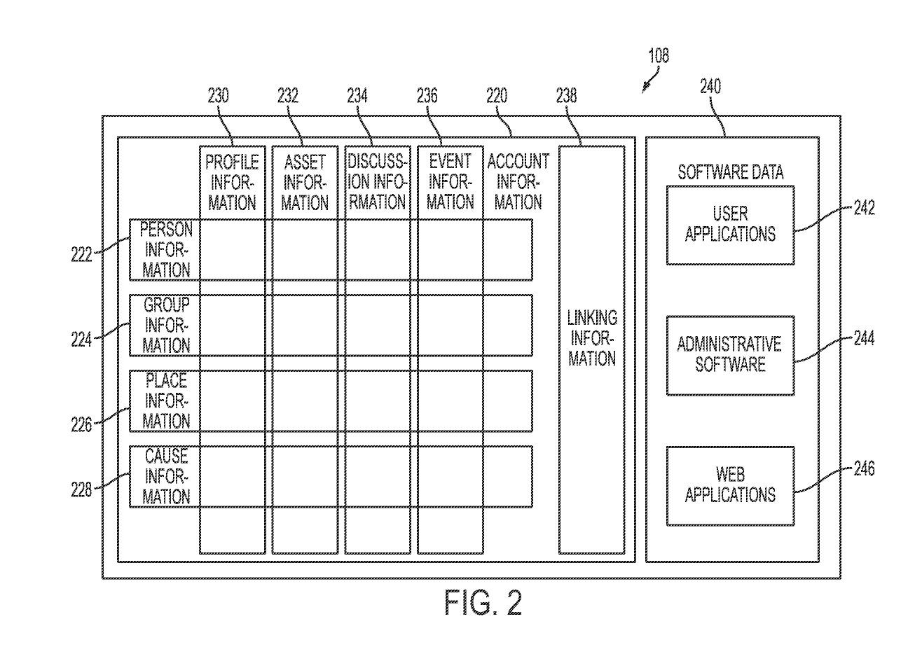

FIG. 2 is a block diagram of a representative organization for the database 108 of FIG. 1. Referring to FIGS. 1 and 2 together, the database 108 may be configured to store account information for the users and computer-readable instructions for enabling interactions between the users. Accordingly, the database 108 may be configured to store data that may be described in terms of information modules and process modules. Those of ordinary skill in the art will recognize that this organization may be useful for description purposes, and that some information and processes may overlap both the information modules and the process modules.

The information modules may be generally described as account information 220, and the process modules may be generally described as software data 240. Of course, the partitioning of the database 108 is representative of an embodiment of the present disclosure. Other partitioning solutions, or no partitioning at all, may be used with embodiments of the present disclosure.

By way of example, and not limitation, some information and processes are listed below and in FIG. 2 to indicate the type of information and processes that may be used in the communication system 100. This listing is intended to be exemplary only, and not an exhaustive list of the information and processes used or stored in the communication system 100.

The account information 220 may include information for user accounts corresponding to the users. As previously discussed, user accounts may be established for different types of users, such as individual people, groups of people, places, and causes. Accordingly, the account information 220 may include person information 222, group information 224, place information 226, and cause information 228.

In some embodiments, user accounts corresponding to groups, places, and causes may be created by users with person accounts. Also, a person (e.g., the person who created the group, place, or cause account) having a person user account may be designated as an administrator for each group, place, and cause account. Accordingly, account information 220 may include information indicating users that created, or administer the user accounts. Furthermore, a group may include a plurality of person users, each corresponding to a person, place, other group, or cause account. Accordingly, group information 224 may include information indicating users that are part of the group. By way of non-limiting example, the account information 220 may include profile information 230, asset information 232, discussion information 234, and event information 236, each of which may be associated with appropriate person information 222, group information 224, place information 226, and/or cause information 228. The profile information 230 may include information about the users (e.g., individual persons, groups, places, or causes) that may be accessed by other users through the user devices 104. For example, the profile information 230 may include information about the users' interests, geographical location, and other information that the users may provide for sharing with the other users. The profile information 230 may enable the users to find other users with common interests and similar geographical locations of interest. The profile information 230 may also serve to enable new businesses, local artists, and causes to share information (e.g., offers, interests, products, etc.) with other users.

The asset information 232 may include information indicative of assets that are associated with each of the plurality of user accounts. The asset information 232 may also include redemption designations corresponding to each of the assets included in the asset information 232. By way of non-limiting example, the users may register the assets associated with their user accounts for sale, for trade, for rent, for free-of-charge lending, or combinations thereof. The asset information 232 may further include cause benefit information indicating causes that receive at least a portion of the profits earned through selling or renting of the assets. By way of non-limiting example, the users may indicate a cause and a percentage of the proceeds that may go to the cause if profits are made with a certain asset.

The asset information 232 may include information that is associated with a particular user account type (e.g., individual user account, group account, place account, cause account, etc.). By way of non-limiting example, place user accounts corresponding to restaurants and merchants may include menus and catalogs, respectively.

The event information 236 may include information about events at various planning stages organized by the users. Events may comprise gatherings of people at physical locations, such as, for example, the social centers 106. By way of non-limiting example, events may comprise classes, meetings, deals offered by places (e.g., a discount for a predetermined period of time at a specific location), service projects, lectures, political assemblies, auctions, performances, games, musical performances, and other gatherings. Event information 236 may also include planning stage classification information, such as, for example, tentative, firmly scheduled, cancelled, etc.

The discussion information 234 may include text, audio, and/or image data (e.g., video and still image data) provided by the users during online discussions. Online discussions may include discussions directed to causes, events, assets, groups, people, places, and any other topics of interest. Users may initiate and participate in discussions. By way of non-limiting example, a user with an individual person account may start an online discussion directed to discussing interest for organization of a particular event or group. The user may start an online discussion (also referred to herein as a “spark”) by providing information about the proposed particular event or group, identifying a category the event or group belongs to (e.g., art, yoga, etc.), and a geographical location of the event or group. The information about the proposed particular event or group may be sent to other users that share the similar geographical locations to the proposed event or group, and have interests that correlate to the category of the event or group. The other users may indicate their interest by following/supporting the spark (e.g., by selecting a follow or support option). The other users may also be enabled to comment in the discussion. The user may decide to organize the particular event or group if sufficient demand for the particular event or group is expressed in the online discussion. For example, the user may designate a certain number of users supporting or following the particular event or group before formally organizing the particular event or group. A small fee may be charged to formally organize events, groups, or a combination thereof in order to prevent too many events and groups from being organized.

The account information 220 may also include linking information 238 linking the user accounts to each other and to certain events, discussions, and assets of interest. By way of non-limiting example, the server 102 may be configured to enable the users to follow or support other user accounts (e.g., person accounts, group accounts, cause accounts, and place accounts), events, discussions, and assets. Accordingly, the linking information may include information indicating users that follow/support each of the users, and information indicating users that are followed/supported by each of the users.

Although not depicted in FIG. 2 or discussed herein in detail, the account information 220 may also include payment information (not shown) linked to the plurality of users to enable payment for purchased assets, donations to causes, and other online money-based transactions. Those of ordinary skill in the art will appreciate that many methods of securing payments online are known in the art, which may be used in connection with the present disclosure.

The software data 240 may include process modules comprising computer-readable instructions directed to implementing the functions the server 102 and the user devices 104 are configured to perform. In some embodiments, the software data 240 may include one or more user applications 242 (sometimes referred to herein simply as “user applications” 242). The user applications 242 may comprise computer-readable instructions configured for execution by the user devices 104. The server 102 may be configured to provide the user applications 242 to the user devices 104 (e.g., directly as a download, or indirectly by a third-party software provider) for execution on the user devices 104.

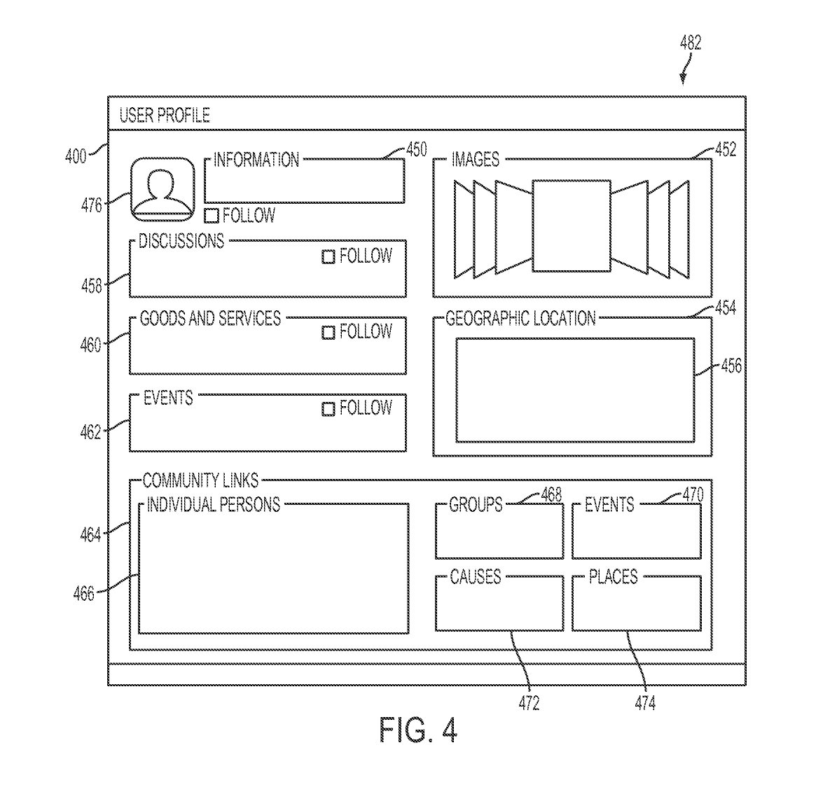

By way of non-limiting example, the computer-readable instructions of the user applications 242 may be directed to providing a user interface configured for enabling the users to participate in the communication system 100 through the user devices 104. In some embodiments, the user interface may include a graphical user interface, such as, for example, the graphical user interface described with reference to FIGS. 4 through 6, below. In some embodiments, the user applications 242 may include mobile applications for mobile user devices 104 such as, for example, cellular phones, tablet computers, personal digital assistants, etc. Thus, the user applications 242 may be configured for execution in mobile operating system environments (e.g., Android, iOS, WINDOWS® Phone, etc.). In some embodiments, the user applications 242 may include software applications for personal computers (e.g., desktop computers, laptop computers, etc.). Accordingly, the user applications 242 may be configured for execution in computer operating system environments (e.g., WINDOWS®, OS X, Unix, Linux, etc.).

In some embodiments, the software data 240 may include one or more web applications 246 (sometimes referred to herein simply as “web applications” 246). The web applications 246 may include computer-readable instructions configured for execution by the server 102. By way of non-limiting example, the computer-readable instructions of the web applications 246 may be directed to a user interface configured for enabling the users to participate in the communication system 100 through web browsers executed by the user devices 104. In some embodiments, the user interface may include a graphical user interface, such as, for example, the graphical user interface 482 described with reference to FIGS. 4 through 6, below.

The administrative software 244 may include computer-readable instructions configured for execution by the server 102. The computer-readable instructions of the administrative software 244 may be directed to performing the functions the server 102 is configured to perform. By way of non-limiting example, the computer-readable instructions of the administrative software 244 may be directed to interfacing with the mobile applications 242, the web applications 246, or with a combination thereof, to provide and receive the account information 220 for presentation to and input from the users on the user devices 104. Also by way of non-limiting example, the computer-readable instructions of the administrative software 244 may be directed to distributing the user applications 242 to the user devices 104 (e.g., directly, or through a third-party software distributer). As another non-limiting example, the computer-readable instructions of the administrative software 244 may be configured to enable the users to participate in the online trading sessions.

FIG. 3 is a simplified block diagram of the one or more servers 102 of the communication system 100 of FIG. 1. The server 102 may include at least one control circuit 310 (sometimes referred to herein simply as “control circuit” 310) operably coupled to at least one communication element 318 (sometimes referred to herein simply as “communication element” 318) and at least one data storage device 316 (sometimes referred to herein simply as “data storage device” 316). The communication element 318 may be configured to enable the control circuit 310 to communicate with the user devices 104, and the social centers 106 (FIG. 1). As non-limiting examples, the communication element 318 may include elements configured to communicate via wired and wireless communication media, such as, for example, serial ports, parallel ports, Ethernet connections, universal serial bus (USB) connections, IEEE 1394 (“firewire”) connections, BLUETOOTH® wireless connections, 802.1 a/b/g/n type wireless connections, and other suitable communication interfaces and protocols.

The data storage device 316 may include computer-readable media (CRM) configured to store the database 108. The database 108 may be configured to store the account information and software data 240 as discussed above with respect to FIG. 2.

The control circuit 310 may include at least one processing circuit 312 (sometimes referred to hereinafter simply as “processing circuit” 312) operably coupled to at least one memory device 314 (sometimes referred to hereinafter simply as “memory device” 314). By way of non-limiting example, the control circuit 310 may transfer computer-readable instructions stored in the database 108 of the data storage device 316 to the memory device 314 for execution by the processing circuit 312. The memory device may include, but is not limited to, volatile storage media. By way of non-limiting example, the memory device 314 may include semiconductor devices such as RAM, DRAM, ROM, EPROM, and Flash memory.

The processing circuit 312 may be configured to execute the computer-readable instructions stored by the memory device 314, the data storage device 316, or a combination thereof. The processing circuit 312, when executing computer-readable instructions, constitutes structure for performing the processes the server 102 is configured to perform and can be considered a special-purpose computer when so configured.

FIG. 4 is an example of a simplified user profile interface 400 of a graphical user interface 482 for presentation to users of the communication system 100 of FIG. 1. The server 102 (FIG. 1) may be configured to provide account information 220 (FIG. 2) associated with a particular user account corresponding to a particular user for presentation to the other users of the communication system 100 via the user profile interface 400 on the user devices 104. In some embodiments, the user profile interface 400 may be accessed by the users following a search (e.g., for users by interest, geographic information, asset, and other account information) and selection of a particular user listed responsive to the search. In some embodiments, the user profile interface 400 may be accessed by users via links to the user profile interface 400 from other interfaces of the graphical user interface 482.

The user profile interface 400 may also be configured for enabling the particular user to edit the account information 220 (FIG. 2) associated with the particular user. In other words, users may change the account information 220 associated with their user accounts by editing the information presented by the user profile interface 400 for their own user profiles when they are logged into their own user account. By way of non-limiting example, the user profile interface 400 may be configured for enabling the particular user to edit the geographic information associated with the particular user's user account.

The user profile interface 400 may include various fields configured to present the account information 220 (FIG. 2) associated with the particular user. The user profile interface 400 may include an information field 450, a user photo field 476, an images field 452, and a geographic location field 454. The information field 450 may be configured to present any information the particular user desires to include in the information field 450, such as, for example, interests, accomplishments, professional experience, etc.

The user photo field 476 may be configured to present an image uploaded to the database 108 (FIG. 1) by the particular user. This image may be referred to herein as a “profile picture.” By way of non-limiting example, the image may include a photograph of a person if the particular user is a person having an individual person account. Likewise, the image in the user photo field 476 may be any image representative of a group for a group account, a place for a place account, and a cause for a cause account.

The images field 452 may be configured to present images the particular user has uploaded to the database 108. The images may comprise still images, video images, or a combination thereof The images field 452 may be configured to enable users to browse through the images, and expand views of selected images.

The geographic location field 454 may be configured to indicate a geographical location that the particular user has associated with the particular user account. The geographical location may include a general or particular geographical location. For example, the geographical location may include a neighborhood, a city, a segment of a city, or a particular address within the city. The geographic location field 454 may include a map 456 configured to present the geographical location that the particular user associated with the particular user account. The geographic location field 454 may assist users to determine a general or particular locality associated with the particular user. Such information may enable users to find people, groups, and causes with common interests, and places that provide assets the users would be interested in within their own communities.

The user profile interface 400 may also include a discussion field 458, an assets field 460, and an events field 462. The discussion field 458 may be configured to present text corresponding to online discussions associated with the particular user, and that the particular user started. The discussion field 458 may also be configured to enable users to participate in the discussions. For example, the discussion field 458 may be configured to receive text inputs from users viewing the user profile interface 400, and display the text in the discussion field 458.

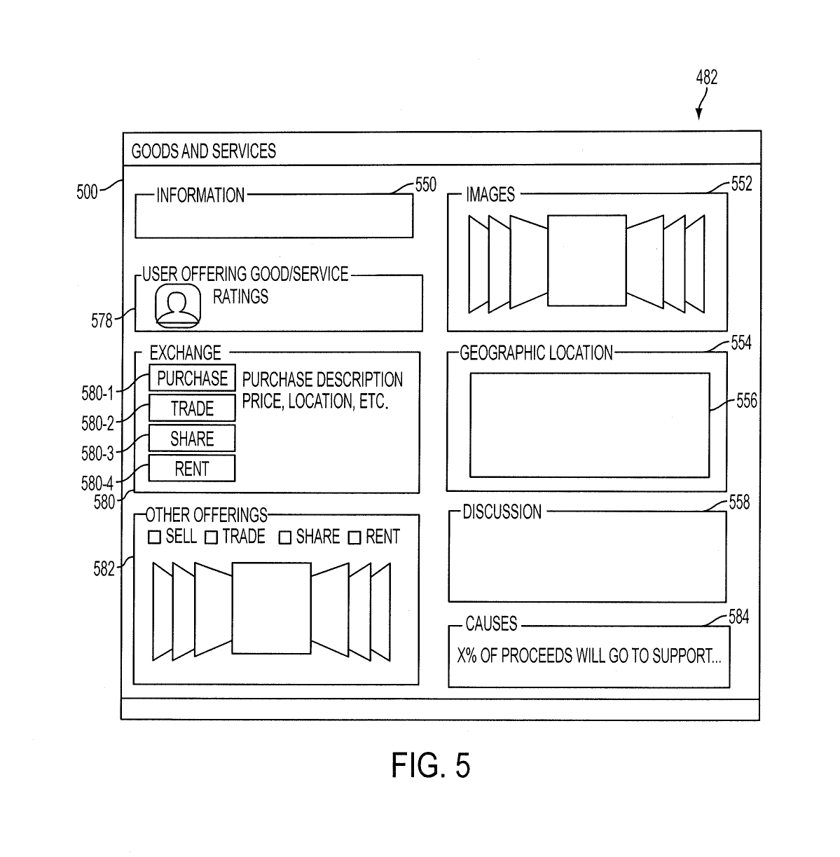

The assets field 460 may be configured to indicate the particular person's assets that are posted for trade, for sale, for rent, and for free-of-charge lending. In some embodiments, the assets field 460 may include a link to redirect users viewing the user profile interface 400 to an assets interface that provides more information about the particular assets, such as, for example, the assets interface 500 illustrated in FIG. 5.

The events field 462 may be configured to indicate events that the particular user initiated. The events field 462 may also be configured to indicate details about the events (e.g., locations, dates, times, recurrence, etc.). The events field 462 may further be configured to enable users viewing the user profile interface 400 to sign up to attend the events indicated by the events field 462.

Each of the discussion field 458, the assets field 460, and the events field 462 may be configured to enable users viewing the user profile interface 400 to link discussions, assets, and events indicated by the respective discussion field 458, assets field 460, and events field 462 to their own user accounts. By way of non-limiting example, the user profile interface 400 may be configured to enable the users to follow or support the discussions, assets, and events indicated by the discussion field 458, the assets field 460, and the events field 462, respectively. In addition, the user profile interface 400 may be configured to enable the users to follow or support the particular user profile. In other words, the user profile interface 400 may be configured to link users viewing the user profile interface 400 to the particular user (e.g., individual person, group, place, or cause), and the particular user's discussions, assets, and events. The server 102 may be configured to store the linking information 238 (FIG. 2) including data indicative of links between individual user accounts and discussions, assets, and events (e.g., supporting or following, supported by or followed by, etc.).

The user profile interface 400 may further be configured to indicate the links between the particular user and the other users, and between the particular user and the other users' discussions, assets, and events. These links may be referred to herein simply as “user links.” For example, the user profile interface 400 may include a community links field 464 configured to indicate the particular user's user links. For example, the community links field 464 may comprise an individual persons field 466 configured to indicate individual person users that are linked to the particular user (e.g., individual persons that are following the particular user, and that the particular user is following). Also, the community links field 464 may include a groups field 468, a causes field 472, and a places field 474 indicating group users, cause users, and place users, respectively, that are linked to the particular user (e.g., groups, causes, and places that are following the particular user, and that the particular user is following). Furthermore, the community links field 464 may include a community events field 470 configured to indicate events that are linked to the particular user (e.g., events that the particular user is organizing, is planning to attend, is following, is followed by, etc.). In some embodiments, the user profile interface 400 may enable users to select individual persons, groups, causes, and places, and be redirected to a user profile interface 400 for the selected individual person, group, cause, or place.

The user profile interface 400 thus configured may enable users to access information about the particular user. The user profile interface 400 also may enable users to be linked to various individual persons, groups, places, causes, discussions, assets, and events. Accordingly, the server 102 may provide various forms of information regarding the users, and linking information 238 about how the users are linked to other users, discussions, assets, and events through the graphical user interface 482 displayed on the user devices 104.

FIG. 5 is an example of a simplified assets interface 500 of the graphical user interface 482 for presentation to users with the user devices 104 of the communication system 100 of FIG. 1. The assets interface 500 may be configured to enable users to access information about a particular asset stored as asset information 232 (FIG. 2) in the database 108 of the server 102 (FIG. 1). In other words, the assets interface 500 may serve as a “profile page” for a particular asset. In some embodiments, other users may access the assets interface 500 by selecting a link to the assets interface 500 in the assets field 460 of FIG. 4. In some embodiments, the other users may access the assets interface 500 by performing an online search and selecting a link to the assets interface (e.g., a link associated with the particular asset).

The assets interface 500 may include an information field 550, a user field 578, an exchange field 580, an other offerings field 582, an images field 552, a geographic location field 554, a discussion field 558, and a causes field 584. The information field 550 may present information provided by the user associated with the particular asset. For example, the information field 550 may present information describing the asset, an asking sale price of the asset, limits on use of asset if it is for rent or for free-of-charge lending, reasons for listing the asset as a user asset, other assets the particular user may be willing to trade for the particular asset, or other information.

The user field 578 may be configured to provide information about a particular user that offering the particular asset selected. By way of non-limiting example, the particular user's profile picture may be displayed in the user field 578. Also by way of non-limiting example, the user field 578 may be configured to provide ratings from other users that have previously had dealings with the particular user.

The exchange field 580 may be configured to enable the users to indicate a method of exchanging for the particular asset. By way of non-limiting example, the exchange field 580 may be configured to present a purchase option 580-1, a trade option 580-2, a share option 580-3, and a rent option 580-4. In some embodiments, each of the purchase option 580-1, the trade option 580-2, the share option 580-3, and the rent option 580-4 may be enabled or disabled responsive to the redemption designations (e.g., for sale, for rent, for trade, for free-of-charge lending, or a combination thereof) corresponding to the particular asset. In other words, if the particular asset is only listed as for trade and for free-of-charge lending, the trade option 580-2 and the share option 580-3 may be enabled, and the purchase option 580-1 and the rent option 580-4 may be disabled.

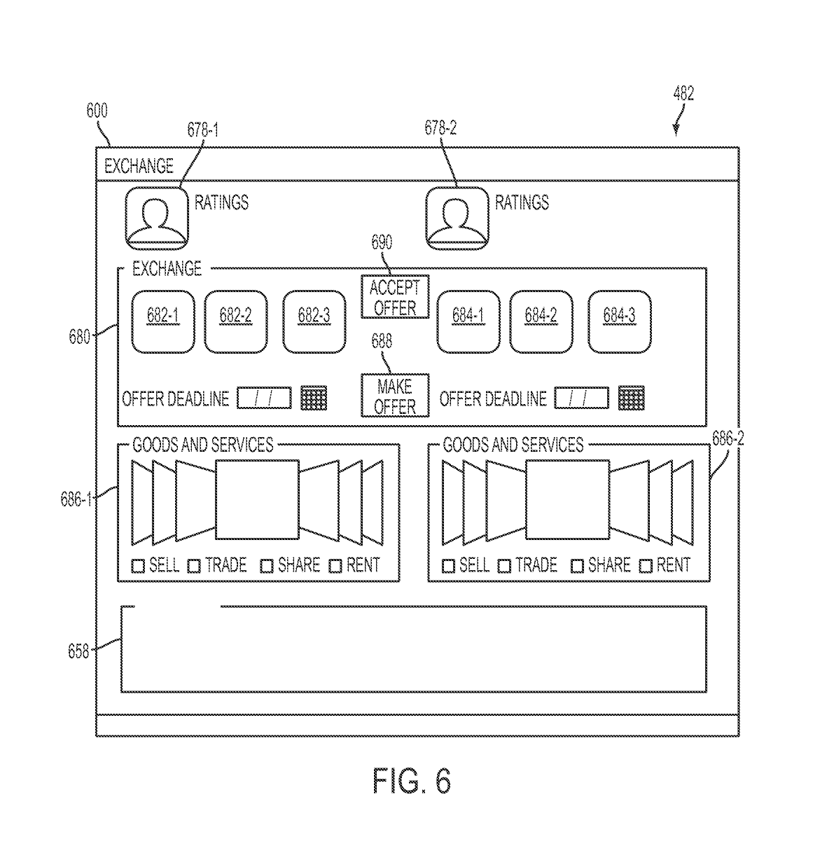

Responsive to a user selection of the purchase option 580-1, the server 102 (FIG. 1) may enable the user to purchase the particular asset online. In some embodiments, the server 102 may provide the assets interface 500 with instructions for the user to complete an online purchase transaction, or redirect the user to another interface that is capable of completing the online purchase transaction. For example, the user may be redirected to a payment page with payment options (e.g., credit card, PAYPAL®, GOOGLE® payments, AMAZON® payments, etc.) where the user may enter any information required to make a purchase. In some embodiments, the assets interface 500 may be configured to enable the user to make an offer to purchase the particular asset, and the offer may be reviewed and accepted or denied by the particular user (e.g., via an exchange session interface 600, as discussed with respect to FIG. 6).

In some embodiments, the assets interface 500 may be configured to enable the user to agree to a method of physically making the delivery of the purchased asset. For example, the users may agree to meet at a certain time and place (e.g., a social center 106, another place with a place user account associated therewith, or other geographic location) to make the physical delivery. As another example, the particular user may agree to leave the purchased asset at a social center 106, and the user that purchased the asset may subsequently pick up the asset at the social center 106. As a further example, the particular user may agree to ship asset to the user that purchased the asset. In some embodiments, a shipping service may be provided that ships assets left at a first social center 106 located proximate the particular user a second social center 106 located proximate the user that purchased the asset. The payment may be held in escrow until the party that purchased the asset confirms receipt of the asset. The asset information 232 corresponding to the purchased asset may then be disassociated with the particular user's user account, and removed from the database 108.

Responsive to a user selection of the trade option 580-2, the assets interface 500 may enable the users to enter online exchange sessions with the particular user. In some embodiments, the assets interface 500 may be configured to redirect the user to the exchange session interface 600 (FIG. 6) configured to enable the online exchange session. More detail regarding the exchange session interface 600 is discussed below with reference to FIG. 6.

Responsive to a user selection of the share option 580-3 or the rent option 580-4, the assets interface 500 may provide the user with information about the availability and terms associated with borrowing the particular asset free-of-charge (e.g., temporary or permanent), or renting the particular asset (e.g., rental fees, period of time for renting the asset), respectively. The assets interface 500 may provide instructions to the user for redeeming and returning the borrowed or rented assets, or redirect the user to another interface that is capable of completing the online transaction. If the user selected the rent option 580-4, the user may be redirected to a payment page, similar to that discussed above with respect to the purchase option 580-1. In some embodiments, responsive to a user selection of the share option 580-3, the user may be redirected to the exchange session interface 600 to complete the transaction. When the online transaction is complete, the parties may agree to a method of physical delivery, as also discussed above with respect to the purchase option 580-1.

In some embodiments, the social centers 106 may include lockers for storing items for sale, trade, rent, or free-of-charge sharing. When an online transaction completes, the assets interface 500 may, for example, provide a locker combination to the user that is to redeem the asset (or a voucher, a confirmation code, etc., to present to an operator at the social center 106). As a specific non-limiting example, a group account may be formed for sharing camping equipment. The group may reserve lockers in a social center 106 for storing camping equipment belonging to the members of the group. When a member of the group wishes to borrow some of the camping equipment, the member may access the assets interface 500 to borrow the camping equipment, and pick up the camping equipment from the social center 106. Accordingly, collectives may be formed for free-of-charge sharing.

In some instances where the particular user is a place user offering the particular asset, the particular asset may be redeemable at a geographical location associated with the place. Also by way of non-limiting example, the particular asset may be redeemable at a retail location or restaurant. By way of non-limiting example, the particular asset may be a menu item offered by the restaurant area of the social center 106. Users may be enabled to purchase the menu item on a user device 104 (FIG. 1) (their own device, or a device provided in the social center 106).

The other offerings field 582 may be configured to indicate other assets that the particular user is offering. In other words, the other offerings field 582 may be configured to indicate other assets corresponding to asset information 232 (FIG. 2) associated with the particular user's user account. In some embodiments, the other offerings field 582 may be configured to enable the users to select from the other assets indicated in the other offerings field 582, and redirect the user to a assets interface 500 for the selected other asset.

The other offerings field 582 may also be configured to enable the users to control which of the other assets associated with the particular user's user account are indicated in the other offerings field 582. By way of non-limiting example, the other offerings field 582 may be configured to enable the users to indicate the other assets that are listed as for sale, for trade, for free-of-charge lending, for rent, or for combinations thereof. In other words, the other offerings field 582 may be configured to enable the users to selectively view the other assets that are for rent, for trade, for free-of-charge lending, for rent, or combinations thereof Other controls for the other offerings field 582 are also contemplated, such as, for example, sorting controls (e.g., by price, by listing date, by number of user views, etc.).

The images field 552 may be configured to present images of the particular asset, or images associated with the particular asset. The images may include still images, video images, or a combination thereof. By way of non-limiting example, the images may include photographs of the particular asset if the particular asset is a good, or videos of the particular asset being used. Also by way of non-limiting example, the images may include photographs or videos of a person rendering a service if the particular asset is a service. The images field 552 may also be configured to enable the users to select an image, and view a larger version of the selected image.

The geographic location field 554 may be configured to indicate a geographic location of the particular asset. In some embodiments, the geographic location field 554 may include a map 556 configured to indicate the geographic location. The geographic location of the particular asset may be a general or particular geographic location corresponding to where the particular asset may be redeemed. By way of non-limiting example, the geographic location may be a general neighborhood where the particular user lives if the particular asset is in the possession of the particular user. Also by way of non-limiting example, the geographic location may be an address of a social center 106 that is in possession of the particular asset. As a further example, the geographic location may be an address of a social center 106 where a service will be rendered if the particular asset is a service (e.g., classes, lessons, etc.).

The discussion field 558 may be configured to enable the users to engage in online discussions about the particular asset. By way of non-limiting example, the particular user may ask the other users to comment as to the value of the particular asset. Also by way of non-limiting example, the users may ask questions about the particular asset. Also, the users may discuss the particular asset with each other.

The causes field 584 may be configured to indicate any causes that will receive a donation from at least a portion of any proceeds earned by the asset. By way of non-limiting example, the particular user may indicate that a certain percentage of the proceeds will be donated to a particular cause. As a specific, non-limiting example, 10% of the profits earned from a health food store's sales may go to combatting obesity. The server 102 may be configured to automatically extract the portion of the proceeds designated to go to the particular cause responsive to any online transactions, and transfer the portion of the proceeds to the particular cause (e.g., if the particular cause has a cause user account associated therewith).

FIG. 6 is an example of a simplified exchange session interface 600 of the graphical user interface 482 for presentation to users with the user devices 104 of the communication system 100 of FIG. 1. The exchange session interface 600 may be configured to enable a first user to browse through assets corresponding to the first user's user account, browse through the assets corresponding to a second user's user account, and formulate offers for trades with the second user. The exchange session interface 600 may be configured to indicate the parties involved in the exchange session. For example, the exchange session interface 600 may include a first user indicator 678-1 and a second user indicator 678-2. In some embodiments, the first user indicator 678-1 and the second user indicator 678-2 may include user ratings from other users that have previously dealt with the first user and the second user.

The exchange session interface 600 may also include an exchange field 680, a first assets field 686-1, a second assets field 686-2, and a discussion field 658. The first assets field 686-1 and the second assets field 686-2 may be configured to indicate assets corresponding to the first user's user account and assets corresponding to the second user's user account, respectively. The assets indicated in the first assets field 686-1 and the second assets field 686-2 may be selectable by the first user. Selected assets from the first assets field 686-1 may be indicated in the exchange field 680 as first selected assets 682-1, 682-2, 682-3 (sometimes referred to herein simply together as “first selected assets” 682). Similarly, selected assets from the second assets field 686-2 may be indicated in the exchange field 680 as second selected assets 684-1, 684-2, 684-3 (sometimes referred to herein together simply as “second selected assets” 684). In some embodiments, the first assets field 686-1 and the second assets field 686-2 may be configured to enable the first user to designate the first selected assets 682 and the second selected assets 684 assets as proposed to sell, trade, rent, or share.

The exchange field 680 may be configured to enable the first user to construct and submit exchange offers. For example, the exchange field 680 may be configured to indicate the first selected assets 682 and the second selected assets 684. The first selected assets 682 and the second selected assets 684 may be removable from the exchange field 680. Also, the exchange field 680 may include a “make offer” option 688 configured to enable the first user to make an offer to the second user to exchange the assets corresponding to the first selected assets 682 for the assets corresponding to the second selected assets 684. As a result, the exchange session interface 600 may enable the first user to construct and submit online exchange offers to the second user by adding and removing assets in the first assets field 686-1 and the second assets field 686-2 to and from the exchange field 680, and submitting the offer via the “make offer” option 688.

The online exchange offers may include offers to trade the first user's assets for the second user's assets. By way of non-limiting example, the first user may select and designate one or more of the assets in the first assets field 686-1 as proposed to trade, and one or more of the assets in the second assets field 686-2 as proposed to trade, and select the “make offer” option 688. Responsive to the selection of the “make offer” option 688, an online offer to trade may be sent to the second user.

The online exchange offers may also include offers to sell the first user's assets to the second user or offers for the first user to buy the second user's assets. By way of non-limiting example, the first user may select and designate one or more of the assets in the first assets field 686-1 as proposed to sell, without selecting any of the assets in the second assets field 686-2. The exchange session interface 600 may also be configured to enable the first user to designate a price for the first selected assets 682. Responsive to a selection of the “make offer” option 688, an online offer to sell may be sent to the second user. Also by way of non-limiting example, the first user may select and designate one or more of the assets in the second assets field 686-2 as proposed to sell, without selecting any of the assets in the first assets field 686-1. The exchange session interface 600 may also be configured to enable the first user to designate a price for the second selected assets 684. Responsive to a selection of the “make offer” option 688, an online offer to buy may be sent to the second user. As a further non-limiting example, the first user may select and designate one or more of the assets in the first assets field 686-1 as proposed to sell, and one or more of the assets in the second assets field 686-2 as proposed to sell. Responsive to a selection of the “make offer” option 688, an online offer for a two-way sale may be sent to the second user.

The online exchange offers may further include offers to rent out the first user's assets to the second user, and offers for the first user to rent the second user's assets from the second user. By way of non-limiting example, the first user may select and designate one or more of the assets in the first assets field 686-1 as proposed to rent, without selecting any of the assets in the second assets field 686-2. The exchange session interface 600 may also be configured to enable the first user to designate a rental fee for the first selected assets 682. Responsive to a selection of the “make offer” option 688, an online offer to rent may be sent to the second user. Also by way of non-limiting example, the first user may select and designate one or more of the assets in the second assets field 686-2 as proposed to rent, without selecting any of the assets in the first assets field 686-1. The exchange session interface 600 may also be configured to enable the first user to designate a rental fee for the second selected assets 684. Responsive to a selection of the “make offer” option 688, an online offer to rent may be sent to the second user. Similarly to the offer for the two-way sale discussed above, the online exchange offers may include offers for two-way renting (e.g., offers to rent a first asset to the second users and to rent a second asset from the second user, etc.).

The online exchange offers may also include offers to share assets free-of-charge. By way of non-limiting example, the first user may select and designate one or more of the assets in the first assets field 686-1 as proposed to share free-of-charge, without selecting any of the assets in the second assets field 686-2, and select the “make offer” option 688. Responsive to a selection of the “make offer” option 688, an online offer to share free-of-charge may be sent to the second user. Also by way of non-limiting example, the first user may select and designate one or more of the assets in the second assets field 686-2 as proposed to share free-of-charge, without selecting any of the assets in the first assets field 686-1, and select the “make offer” option 688. Responsive to a selection of the “make offer” option 688, an online offer to borrow free-of-charge may be sent to the second user. As a further non-limiting example, the first user may select and designate one or more of the assets in the first assets field 686-1 and one or more of the assets in the second assets field 686-2 as proposed to be shared free-of-charge, and select the “make offer” option 688. Responsive to the selection of the “make offer” option 688, an online offer for a two-way free-of-charge sharing may be sent to the second user. Similarly to the offer for the two-way sale discussed above, the online exchange offers may include offers for two-way free-of-charge sharing (e.g., offers to share a first asset with the second users and to have a second asset from the second user shared with the first user, etc.).

The online exchange offers may additionally include permutations of offers to sell, trade, rent, or share. Also, the online exchange offers may include one-way and two-way offers that include permutations of offers to sell, trade, rent, or share. By way of non-limiting example, the first user may select and designate a first asset in the first assets field 686-1 as proposed to sell, and designate a sale price. The first user may also select and designate a second asset in the first assets field 686-1 as proposed to share free-of-charge. Responsive to the first user selecting the “make offer” option 688, an online offer to sell the first asset to the second user and to share the second asset with the second user free-of-charge may be sent to the second user. In other words, the first user may be enabled to entice the second user to purchase the first asset by offering to share a second asset free-of-charge.

Also by way of non-limiting example, the first user may select and designate a first asset in the second assets field 686-2 as proposed to sell, and a second asset in the first assets field 686-1 as proposed to rent to the second user. Responsive to the first user selecting the “make offer” option 688, an online offer to purchase the first asset from the second user, and rent the second asset to the second user may be sent to the second user. An exemplary situation where such an offer may be useful is between students desiring to purchase and rent textbooks. The first user may desire to purchase a first textbook (the first asset) from the second user, but may not desire to pay the full asking price. The second user may be more willing to sell the first textbook at a lower price in exchange for renting a second textbook (the second asset) from the first user for a semester.

Other offers with permutations of proposals to sell, trade, rent, or share assets with varying levels of complexity may be enabled through the exchange session interface 600, but are not discussed further herein.

In some embodiments, the exchange field 680 may also be configured to enable the first user to place a time limit for the second user to respond to an online exchange offer. By way of non-limiting example, the exchange field 680 may be configured to enable the first user to provide an offer deadline. In some embodiments, a predetermined period of time for reply (e.g., 10 hours, 12 hours, 24 hours, three days, etc.) to online exchange offers may be imposed. Once the time period for reply expires, the online offer may be automatically removed.

The exchange session interface 600 may also be configured to enable the second user to respond to online exchange offers from the first user. Responsive to receiving an online exchange offer, the second user may be enabled to view the exchange session interface 600 on a user device 104. The exchange session interface 600 may include an accept offer option 690. Responsive to the second user selecting the accept offer option 690, the online exchange may be completed. By way of non-limiting example, teens for the exchange of assets may be agreed to (e.g., shipping of assets, meeting to exchange assets and money, scheduling dates and times for rendering services, etc.).

The exchange session interface 600 may further be configured to enable the second user to make counter-offers to the first user. The exchange session interface 600 may be configured to enable the second user to add and remove assets to and from the exchange field 680, and change the designation (e.g., proposed to sell, trade, rent, or share) of the first selected assets 682 and/or the second selected assets 684. By way of non-limiting example, the second user may receive an offer to rent a first selected asset 682-1 from the first user for a proposed rental fee. If the second user does not wish to rent the first selected asset 682-1 from the first user for the proposed rental fee, the second user may change the proposed rental fee, change the designation to proposed to sell and enter a proposed sale price, add other assets with various designations from the first assets field 686-1 and/or the second assets field 686-2 to the exchange field 680, or combinations thereof, and select the “make offer” option 688. A counter-offer may be sent to the first user. Similar to the time limits imposed on the offers, time limits may also be imposed on counter-offers.

The first user may then respond to the counter-offer by selecting the accept offer option 690, changing the counter-offer and submitting another counter-offer to the second user, or letting the counter-offer expire. The first user and the second user may send offers and counter offers back and forth in this manner until agreement is reached, or the online exchange session expires due to lack of response. In some embodiments, the online exchange session may also end responsive to a selection of an end session option (not shown).

If agreement is reached, the first user and the second user may agree to a method of physically making the agreed exchanges. For example, the users may agree to meet at a certain time and place (e.g., a social center 106, another place with a place user account, or other geographic location) to make the physical exchange. As another example, the users may agree to leave their traded assets involved in the online exchange at a social center 106 on a first day, and pick up their traded-for assets at the social center 106 on a proceeding day. As a further example, the users may agree to ship assets to each other. In some embodiments, a shipping service may be provided that ships assets left at a first social center 106 located proximate a first user participating in an online exchange to a second social center 106 located proximate a second user participating in the online exchange. The asset information 232 (FIG. 2) corresponding to the exchanged assets is then disassociated with the first user and the second user, and removed from the database 108.

The discussion field 658 may be configured to enable the first user and the second user to communicate with each other. By way of non-limiting example, the first user and the second user may indicate in the discussion field 658 why an offer or counter-offer was not accepted, what kinds of assets and terms are sought, and other information relevant to the online exchange session.

FIG. 7 is a simplified plan view of a social center 106 of the communication system 100 of FIG. 1. The social center 106 may have a place user account associated with the social center 106. Accordingly, the database 108 of the server 102 may store place information 226 including profile information 230, asset information 232, discussion information 234, event information 236, and other information associated with the social center's 106 place user account, as described above with respect to FIG. 2.

The social center 106 may be configured to provide a physical location or facility for use by the users of the communication system 100. Accordingly, the social center 106 may comprise at least a part of a physical building. By way of non-limiting example, the social center 106 may serve as a gathering place for groups associated with group user accounts, a restaurant, a venue for events corresponding to event information 236 in the database 108, a place to store user assets corresponding to asset information 232, and a retail venue to sell assets corresponding to the asset information 232. Accordingly, the social center 106 may include a dining area 701, an event area 703, a retail area 705, storage areas 707, and restrooms 709. In some embodiments, each of the dining area 701, the event area 703, the retail area 705, and the storage areas 707 may be substantially separated from the others of the dining area 701, the event area 703, the retail area 705, and the storage areas 707 by permanent walls 725, movable partitions 721, or combinations thereof. In some embodiments, one or more of the dining area 701, the event area 703, the retail area 705, and the storage areas 707 may not be separated from at least another of the dining area 701, the event area 703, the retail area 705, and the storage areas 707 by a physical boundary. In some embodiments, two or more of the dining area 701, the event area 703, the retail area 705, and the storage areas 707 may be configured as a single area. By way of non-limiting example, the dining area 701 and the event area 703 may be configured together as a single area.

The dining area 701 may include seating for guests, and equipment for preparing and serving food. A menu of the food items provided in the dining area 701 may be stored as asset information 232 corresponding to the place user account associated with the social center 106. Accordingly, users may access the menu with the user devices 104. One or more user devices 104 may be provided in the dining area 701, but the users may access the menu on their own user devices 104 (e.g., their tablets, smartphones, laptop computers, etc.). The users may also be enabled to purchase menu items online with the user devices 104 (e.g., via the assets interface 500 of FIG. 5). As a result, the users may enter the dining area, sit in the provided seating, and order and purchase menu items without standing in line. In addition, the users may purchase the menu items online before arriving at the dining area 701, and pick up their food in the dining area 701 upon arrival at the dining area 701.

In some embodiments, physical menus may also be provided. In some embodiments, the physical menus may include information that enables users to navigate to an interface (e.g., the assets interface 500 of FIG. 5) that enables the users to purchase particular menu items online. By way of non-limiting example, the physical menus may include QUICK RESPONSE CODES™ (sometimes referred to herein simply as “QR Codes”), bar codes, or other media that may be scanned by a user device 104 to direct the user device 104 to navigate to the interface and enable the user to purchase the menu items. Also by way of non-limiting example, the physical menus may include information (e.g., Internet uniform resource locators (URLs), unique identifiers, etc.) that may be input by the users to the user devices 104 to enable the users to navigate to the interface and purchase the menu items. Also, in some embodiments, the dining area 701 may include a point of sale station configured to accept standard payment for menu items, such as, for example, cash, check, and credit cards.

The event area 703 may be configured as a physical venue for events corresponding to the event information 236 (FIG. 2). As previously discussed, events may include gatherings, such as, for example, classes, service projects, lectures, political assemblies, auctions, performances, and other gatherings. Accordingly, the event area 703 may include, for example, tables 723, chairs, blackboards, teleconferencing equipment, audio/video equipment, and other equipment useful for events. It should be noted that equipment that is not needed for a certain event may be placed in the storage areas 707, and retrieved when needed.

The server 102 may enable the users to schedule and register to attend events in the event area 703 using any of the user devices 104. Accordingly, the server 102 may be configured to store information corresponding to events scheduled to occur in the event area, and information regarding availability of the event area, in the database 108 (e.g., in the event information 236 (FIG. 2) corresponding to the social center's 106 place user account). By way of non-limiting example, when a user creates an event via a user device 104, the server 102 may cause the user device 104 to present the user with an option to hold the event in available event areas 703 of any of several social centers 106 (FIG. 1). In some embodiments, a fee may be charged for use of the event area 703. The server 102 may store an event calendar in the database 108. The event calendar may include information about the events scheduled to occur in the event area 703. The event calendar may, for example, be stored as event information 236 corresponding to the social center's 106 place user account. The event calendar may be accessed by the users with the user devices 104 (e.g., via the user profile interface 400 of FIG. 4). Also, the event calendar may be displayed by an electronic display 713 in the social center 106. The users may be enabled to sign up for the events with the user devices 104.

The retail area 705 may include space for displaying assets corresponding to the asset information 232 (FIG. 2) stored in the database 108 (FIG. 1). In some embodiments, the retail area 705 may include shelves 727 for displaying the assets. In some embodiments, the social center 106 may be a distributor for certain assets. Accordingly, information about the assets distributed by the social center 106 may be stored as account information 232 in the database 108, and the assets may be placed on the shelves 727 in the retail area 705. In some embodiments, the other users may be enabled to sell, rent out, or lend free-of-charge the assets corresponding to their user accounts in the retail area 705. A fee may be charged for the use of the space in the retail area 705 (e.g., a percentage of the proceeds, a flat fee, etc.).

In some embodiments, users may obtain space for their assets in the retail area 705 online via the user devices 104. By way of non-limiting example, the account information 220 (FIG. 2) associated with the social center 106 may include information about the availability of retail space in the social center 106, and information about the assets that are in the retail areas 705 of the social centers 106. The users may indicate assets they desire to place in the retail area 705, and the server 102 may reserve the available retail space for the indicated assets. The users may then deliver the assets to the retail area 705 in person, or by shipping the assets to the social center 106. An operator at the social center 106 may place the assets in the retail space of the retail area 705, and confirm to the server 102 that the assets have been delivered to the social center 106. The asset information 232 (FIG. 2) corresponding to the assets received at the social center 106 may be altered to indicate the proper geographic location of the asset as at the social center 106.

In some embodiments, the social center 106 may enable the users to obtain space for their assets in the retail area 705 in person. By way of non-limiting example, the social center 106 may include a desk (not shown) for receiving assets for placement in the retail area 705. An operator (not shown) at the social center 106 may check the database 108 for availability of retail space in the retail area 705, and receive and place the assets in the retail space. The asset information 232 (FIG. 2) corresponding to the assets received at the social center 106 may be altered to indicate the proper geographic location of the asset as at the social center 106.

The retail area 705 may be open to the public, and people (whether users of the communication system 100 or not) may redeem (e.g., purchase, rent, borrow, etc.) the assets in the retail area 705 as in any retail center (e.g., with cash, check, and credit cards). Users of the communication system 100 may also be enabled to redeem the assets online. By way of non-limiting example, information may be provided about the assets to enable the users to view and complete online transactions (e.g., purchases, trades, renting, borrowing, etc.) for obtaining the assets with the user devices 104. Scannable media (e.g., QR codes, barcodes, or other scannable media) or other information (e.g., unique asset identifiers, URLs, etc.) capable of directing the user devices 104 to an interface enabling the online transactions (e.g., the assets interface 500 of FIG. 5) may be presented with the assets in the retail area 705. The users may use their own user devices 104, or user devices 104 provided in the retail area 705 to complete online transactions for obtaining the assets in the retail area 705. An operator at the social center 106 may authorize the removal of assets obtained through the online transactions or otherwise redeemed (e.g., with cash, check, credit cards, etc.) from the retail area 705.

The storage areas 707 may be configured to store any of the equipment needed in the social center 106. By way of non-limiting example, food items for the dining area 701, assets to sell in the retail area 705, equipment for the event area 703, and other items may be stored in the storage area 707. The storage area 707 may include space for storing assets that the other users desire to store in the storage area 707 (e.g., for a fee). Furthermore, the storage area 707 may include space for storing assets involved with online transactions. For example, the parties to an online exchange session may agree to deliver (in person or through shipping) assets involved with the online exchange session to their local social centers 106. The assets may be shipped to the social centers 106 closest to the parties, and stored in the storage areas 707 of those social centers 106 until the parties redeem the assets at their local social centers 106.

As a specific, non-limiting example, the parties to an online trade of assets for assets may agree to deliver their exchanged assets to the same social center 106. The storage areas 707 may include lockers 729 that may be reserved for the assets, and corresponding locker combinations may be set and provided to the parties (various levels of automation in this process are contemplated). The parties may each deliver their exchanged assets to the designated lockers 729, and the parties may be enabled to pick up their exchanged-for assets from the lockers 729. As another non-limiting example, an operator of the social center 106 may receive the exchanged assets involved in online transactions and place the assets in the storage areas 707, and retrieve and present the assets to the parties when they arrive to redeem their exchanged-for assets.

The social center 106 may also include a computing system 711, which may be located in a storage area 707, as shown in FIG. 7, or in one or more of the others of the dining area 701, the event area 703, and the retail area 705. In some embodiments, the computing system 711 may be located at a desk configured for receiving assets for placement in the retail area 705 or the storage area 707. In some embodiments, different components of the computing system 711 may be located in different areas within the social center 106. By way of non-limiting example, the computing system 711 may include one or more desktop or laptop computers. The computing system 711 may be configured to communicate with the server 102, and access the database 108. For example, the computing system 711 may be configured to enable an operator of the social center 106 to access and maintain the account information 220 (FIG. 2) associated with the social center's 106 place user account. The server 102 may be configured to store information identifying the assets stored in the storage area 707, and assets displayed in the retail area 705, in the database 108.

The computing system 711 may be configured to communicate with the electronic display 713. In some embodiments, the electronic display 713 may be located inside of the social center 106. By way of non-limiting example, the electronic display 713 may be positioned proximate a window to enable people outside of the social center 106 to see a viewing area of the electronic display 713. Also by way of non-limiting example, the electronic display 713 may be positioned to enable people inside the social center 106 to see the viewable area of the electronic display 713. In some embodiments, the electronic display 713 may be located outside the social center 106 (e.g., a marquee, an electronic billboard, etc.). In some embodiments, multiple electronic displays 713 may be positioned inside the social center 106, outside the social center 106, or a combination thereof

As previously discussed, the computing system 711 may be configured to cause the electronic display 713 to display an events calendar indicating upcoming events scheduled for the event area 703. The computing system may also be configured to cause the electronic display 713 to display advertisements for menu items offered in the dining area 701, or assets offered in the retail area 705. The computing system may further be configured to cause the electronic display 713 to display information (e.g., videos, text, images, etc.) about causes that the social center 106 is supporting. In some embodiments, the social center 106 may rent out advertising time on the electronic display to other parties (e.g., users of the communication system 100, or others) to generate revenue, or donate advertising time to causes associated with cause user accounts.

The electronic display 713 may comprise any of various electronic displays known in the art. By way of non-limiting example, the electronic display 713 may include a liquid crystal display (LCD), a plasma display, a display based on projection technology, a cathode ray tube (CRT), an array of light-emitting diodes (LEDs), and other technologies known in the art. The electronic display 713 may be configured for viewing from within the social center 106, or from outside of the social center 106 (e.g., next to a window).

The social center 106 may earn profits through the sale of food items in the dining area 701 and assets in the retail area 705, from the use of the event area 703, the retail area 705, and the storage area 707 by the users, and advertising on the electronic display 713. In some embodiments, a portion of the profits earned by the social center 106 may be donated to a cause (e.g., a cause corresponding to a cause user account). The communication system 100 may enable the users to participate in selecting the causes that should receive donations from the profits of the social center 106. By way of non-limiting example, the server 102 may track each of the users' activity on the communication system 100 in the same geographical area as the social center 106, and/or in the social center 106 itself. Users with more activity may be given greater weight in deciding which causes should receive donations. For example, a vote may be held to decide which causes should receive donations, and the users with more activity may be given votes with more weight than users with less activity.

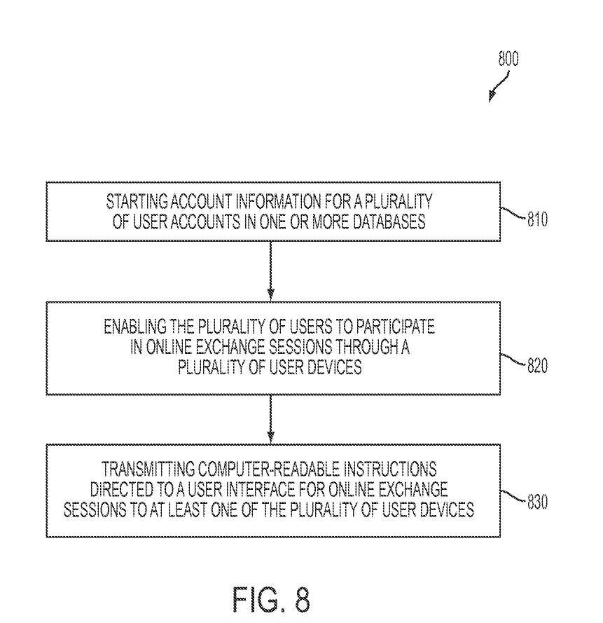

FIG. 8 is a flowchart 800 illustrating a method of administering the communication system 100 of FIG. 1. At operation 810, the method may comprise storing account information 220 (FIG. 2) for a plurality of user accounts corresponding to a plurality of users in one or more databases 108 (FIGS. 1 through 3). The account information 220 may include asset information 232 (FIG. 2) associated with each of the plurality of user accounts.

At operation 820, the method may comprise enabling the plurality of users to participate in online exchange sessions through a plurality of user devices 104. The online exchange sessions may enable each of the plurality of users to negotiate with others of the plurality of users and agree to exchanges of the assets associated with their corresponding user accounts.

At operation 830, the method may comprise transmitting computer-readable instructions (e.g., the user applications 242 of FIG. 2) for execution by the plurality of user devices 104 to at least one of the plurality of user devices 104. In other words, the method may comprise transmitting software for execution by the user devices 104 to at least one of the plurality of user devices 104. By way of non-limiting example, the computer-readable instructions may be directed to a graphical user interface 482 (FIG. 6) for execution by the user devices 104. The graphical user interface 482 may be configured to enable the plurality of users to participate in the online exchange sessions. In some embodiments, transmitting the computer-readable instructions for execution by the plurality of user devices 104 to at least one of the plurality of user devices 104 may comprise transmitting the computer-readable instructions directly to the plurality of user devices 104. In some embodiments, transmitting the computer-readable instructions for execution by the plurality of user devices 104 to at least one of the plurality of user devices 104 may comprise transmitting the computer-readable instructions to a third party (e.g., an online software application store) for distribution to the at least one of the plurality of the user devices 104.

The communication system 100 and the methods described herein may provide online and physical facilities for the exchange of assets and ideas, the promotion of causes, and scheduling and realizing events. The utility and benefit the communication system 100 may provide is not, however, limited to the exemplary embodiments discussed herein. Other uses for the communication system 100 are also contemplated. For example a social center 106 in a location remote from higher education facilities may serve as a venue to provide classes for higher education credit to individuals that otherwise would not have access to higher education. Also, the social centers 106 may provide a venue for local artists to present their work to their communities. Furthermore, the communication system 100 may enable new business establishments (e.g., restaurants, retail businesses, etc.) to inform the local community about themselves. For example, information about assets offered by new businesses may be disseminated through the communication system 100. Also, new businesses may organize events at their places of business, and invite local users to attend the events. For example, a new restaurant may organize an event such as a discussion to address a specific cause during which a discount may be offered on food or drinks, or during which proceeds will be donated to the specific cause.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of embodiments encompassed by the disclosure as contemplated by the inventors.

1. A communication system, comprising:
one or more servers comprising one or more databases configured to store account information for a plurality of user accounts corresponding to a plurality of users, the account information including asset information associated with each of the plurality of user accounts, the asset information indicative of assets that are associated with each of the plurality of user accounts, the one or more servers configured to:
communicate with a plurality of user devices; and
enable the plurality of users to participate in online exchange sessions through the plurality of user devices, the online exchange sessions enabling each of the plurality of users to negotiate with others of the plurality of users and agree to exchanges of the assets associated with their corresponding user accounts.

2. The communication system of claim 1, wherein the one or more servers are further configured to enable the plurality of users to offer the assets associated with their corresponding user accounts online for sale, for trade, for rent, and for lending free of charge.

3. The communication system of claim 1, wherein the one or more servers are further configured to enable the plurality of user devices to display a graphical user interface configured to:
enable a first user of the plurality of users to indicate a second user of the plurality of users to participate in an online exchange session with; and
enable the first user to view the assets associated with a first user account corresponding to the first user and the assets associated with a second user account corresponding to the second user.

4. The communication system of claim 3, wherein the one or more servers are further configured to enable the graphical user interface to:
enable the first user to select from the assets associated with the first user account and the assets associated with the second user account; and
enable the first user to make an online offer to the second user to exchange the selected assets associated with the first user account for the selected assets associated with the second user account.

5. The communication system of claim 4, wherein the one or more servers are further configured to enable the graphical user interface to enable the second user to:
accept the online offer as offered by the first user;
reject the online offer; and
modify the online offer and make a counter-offer comprising the modified online offer to the first user.

6. The communication system of claim 4, wherein the one or more servers are further configured to impose a time limit for the second user to reply to the online offer.

7. The communication system of claim 1, wherein the plurality of user accounts comprises person accounts, group accounts, place accounts, and cause accounts, and wherein the account information includes profile information corresponding to the plurality of user accounts.

8. The communication system of claim 7, wherein the one or more servers are further configured to enable the plurality of users to access at least a portion of the profile information corresponding to the plurality of user accounts.

9. The communication system of claim 1, further comprising a social center including:
at least a part of a physical building; and
a computing system configured to communicate with the one or more servers.

10. The communication system of claim 9, wherein:
the social center includes an event area configured to host events for the plurality of users; and
the account information includes social center account information comprising:
information corresponding to events scheduled to occur in the event area; and
information regarding availability of the event area.

11. The communication system of claim 10, wherein the social center further includes an electronic display operably coupled to the computing system, wherein the computing system is configured to cause the electronic display to display an event calendar including at least a portion of the information corresponding to events scheduled to occur in the event area.

12. The communication system of claim 10, wherein the one or more servers are configured to enable the plurality of users to schedule and register to attend events in the event area using any of the plurality of user devices.

13. The communication system of claim 9, wherein:
the social center includes a dining area configured for selling and serving food;
the account information includes social center account information comprising information corresponding to menu items offered for sale in the dining area; and
the one or more servers are configured to enable the plurality of users to view the information corresponding to the menu items and purchase the menu items online using any of the plurality of user devices.

14. The communication system of claim 9, wherein:
the social center includes a storage area configured to store at least a portion of the assets associated with the plurality of user accounts; and
the one or more servers are configured to store information identifying the assets stored in the storage area.

15. The communication system of claim 9, wherein the social center further includes a retail area including retail space for displaying at least a portion of the assets associated with the plurality of user accounts.

16. The communication system of claim 15, wherein the one or more servers are configured to enable the plurality of users to redeem the assets in the retail area through online transactions.

17. The communication system of claim 9, wherein the one or more servers are configured to enable at least some of the plurality of users to participate in selecting a cause to which at least a portion of profits earned by the social center are donated to.

18. A method of administering a communication system, the method comprising:
storing account information for a plurality of user accounts corresponding to a plurality of users in one or more databases, the account information including asset information associated with each of the plurality of user accounts, the asset information indicative of assets that are associated with each of the plurality of user accounts; and
enabling the plurality of users to participate in online exchange sessions through a plurality of user devices, wherein the online exchange sessions enable each of the plurality of users to negotiate with others of the plurality of users and agree to exchanges of the assets associated with each of the plurality of user accounts.

19. The method of claim 18, further comprising transmitting computer-readable instructions for execution by the plurality of user devices to at least one of the plurality of user devices, the computer-readable instructions directed to a user interface configured to enable the plurality of users to participate in the online exchange sessions.

20. The method of claim 18, further comprising providing a social center configured to assist in physically fulfilling the exchanges of the assets agreed to during the online exchange sessions.
